(19) United States
(12) Patent Application Publication
(10) Pub. No.: US 2011/0283948 A1
(43) Pub. Date: Nov. 24, 2011

(54) Pet Water Feeder

(75) Inventor: Yau Hing WONG, N.T. (HK)

(73) Assignee: PRO-A INNOVATION LIMITED, NEW TERRITORIES (HK)

(21) Appl. No.: 13/113,098

(22) Filed: May 23, 2011

(30) Foreign Application Priority Data
May 24, 2010 (HK) 10105066.6

(51) Int. Cl. A01K 7/00; A01K 29/00

(52) U.S. Cl. 119/74

(57) ABSTRACT

A pet water feeder comprising a first container having a main body and a threaded neck portion, a base portion defining a reservoir and having an inlet portion and an adaptor. The adaptor comprises a first engaging portion for engaging with the threaded neck portion and a second engagement portion for engaging with the inlet portion. This pet water feeder provides a useful choice to the pet loving public and save the environment because staple water bottles, such as soft drink bottles, mineral water bottles, distilled water bottles, or a juice container, could be used with the adaptor to form a pet water feeder, thereby alleviating the need of custom made water bottles.

### BACKGROUND OF THE INVENTION

The present invention relates to pet water feeder, and more particularly to pet water feeders having a container for supplying a continuous flow of water. More specifically, the present invention relates to a pet water feeder having an inverted water container.

Pet water feeders are commonly used to provide drinking water for pets. Typical pet water feeders usually comprise a water container which dispenses drink water into a drinking reservoir which can be easily accessible by a pet to consume the water in the reservoir. The water container of a typical pet water feeder usually has a capacity far exceeding the storage capacity of the reservoir so that a continuous flow of water for an extended period of time can be guaranteed.

A common type of such pet water feeders is the inverted container type which comprises an inverted water container mounted on a stand. An open end, or the lowest end, of the inverted container is dipped into the reservoir and the combined effect of atmospheric pressure and gravitation effect will cause dispense of water into the reservoir once the water level in the reservoir drops below the lowest end of the container. Such a pet water feeder typically includes a moulded reservoir on which there is moulded a threaded receptacle for receiving a corresponding threaded neck portion at the open end of the container. The threaded receptacle defines an inlet through which water from the main body of the container enters the reservoir for consumption by pets. Engagement between the threaded portions on the container neck and the reservoir also provides mechanical support for the water container.

While the inverted-container type pet water feeder provides a useful choice to the pet-loving public, there are nevertheless inherent shortcomings which call for improvements. For example, a pet water feeder could only function when a compatible container is provided, but a typical water container only has a typical life of several months due to growth of algae, living organisms or accumulation of contaminants inside the container. As the inside of a water container is difficult and time consuming to clean, replacement water containers are often required. However, buying of compatible replacement containers would mean travelling to a pet supplies shop, and availability may not be certain. Furthermore, the procurement of new water containers would mean extra requirements of plastics containers which are not environmentally friendly.

Hence, it is desirable if there could be provided improved pet water feeder. At a minimum, it would be advantageous to provide a pet water feeder with adaptor to make it compatible to bottles widely available on the market and reuse consumed bottles.

### BRIEF SUMMARY OF THE INVENTION

According to the present invention, there is provided pet water feeder comprising a first container having a main body and a threaded neck portion, a base portion defining a reservoir and having an inlet portion, and an adaptor; wherein the adaptor comprises a first engaging portion for engaging with the threaded neck portion and a second engagement portion for engaging with the inlet portion. This pet water feeder facilitates the use of generic or staple water bottles, thereby mitigating the need of custom designed bottles.

There are other advantages of using an adaptor to match between a staple bottle and the water bowl. For example, making threads directly on the receptacle of the base reservoir can be costly and inflexible to fit for various bottle thread designs, and a new pet bowl mould may be required to fit for each thread design.

The second engagement portion may be adapted for press-fitted engagement with the inlet portion. This provides convenience to the user while affording tight fit between the components.

The adaptor may comprise a moulded cylindrical peripheral wall having internal threads for engaging with the threaded neck portion, the exterior of the cylindrical peripheral wall being adapted for press-fitted engagement with the inlet portion of the reservoir.

Longitudinally running splines or ribs may be formed on the exterior of the cylindrical peripheral wall, for example, to avoid slipping of the adaptor.

The first container may be a soft drink container, a mineral water container, a distilled water container, or a juice container, moulded of hard plastics, preferable transparent plastics.

The drink container may be a standard-sized plastic bottle for containing drinks for human consumption.

The reservoir may be a moulded of hard plastics, the reservoir defining an open access for drinking by a pet.

The first container may be arranged to discharge liquid from the main body into the reservoir by gravitation.

The adaptor may be adapted for detachable engagement with both the inlet portion of the reservoir and the necked portion of the first container.

The adaptor may be a screw collar having open ends.

A pet water feed according to any of the preceding Claims, wherein the inlet portion on the base portion comprises longitudinally running splines for engagement with the outside of the adaptor.

The simple longitudinally running splines of the base reservoir at the receptacle will involve (1) lower mould cost because of its simplicity, (2) lower injection moulding cost by shorter injection moulding cycle time and (3) eliminate the requirement of new pet bowl mould by building a lot smaller and less costly mould of adaptor for each thread design. The first container may be a bottle having an open end with the threaded neck portion, the bottle being arranged so that the open end of the bottle defines the drinking water level in the reservoir during normal use.

It is also easier to achieve economy of scale on the adaptors by large number of multi-cavities mould because of its small size.

### BRIEF DESCRIPTION OF THE DRAWINGS

Embodiments of the present invention will be explained by way of example with reference to the accompanying drawings, in which:

FIG. 1 is a perspective view showing a pet water feeder of an embodiment of the present invention,

FIG. 2 is a perspective view showing a perspective view of a base portion of the pet water feeder of FIG. 1,

FIG. 3 is a top plan view of the base portion of FIG. 2,

FIG. 4 shows perspective exploded views of the pet water feeder of FIG. 1, and

FIG. 5 shows another perspective exploded views of the pet water feeder of FIG. 1.

FIG. 6 is a bottom plan view of the pet water feeder of FIG. 1, and

FIG. 6A is a front elevation view of FIG. 6 taken about the cross-section line B-B, and

FIG. 6B is a partial plan view of FIG. 1 showing the transverse cross section view of the bottle receptacle.

FIG. 7 is a front elevation view of FIG. 1, and

FIG. 7A is a front elevation view of FIG. 7 taken about the cross-section line C-C.

FIG. 8 is a perspective view showing an embodiment of the adaptor.

FIG. 9 is a perspective view showing an embodiment of the bottle receptacle.

FIG. 10 is a perspective view showing assembly of the adaptor of FIG. 8 and the bottle receptacle of FIG. 9.

### DETAILED DESCRIPTION OF THE INVENTION

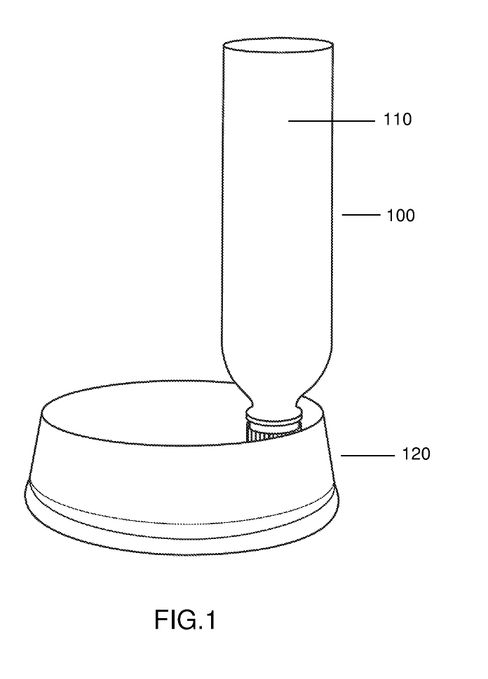

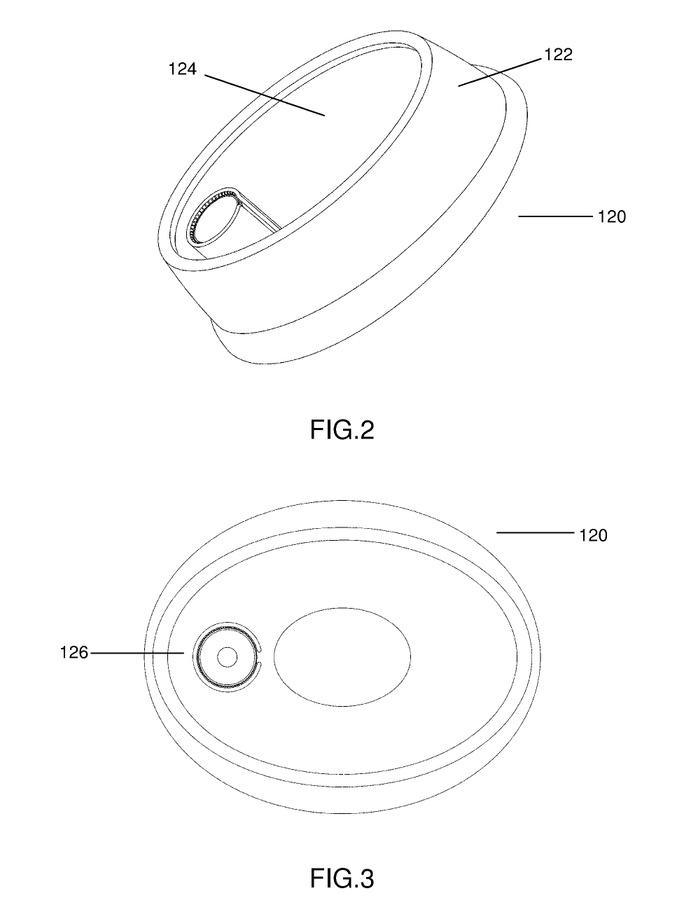

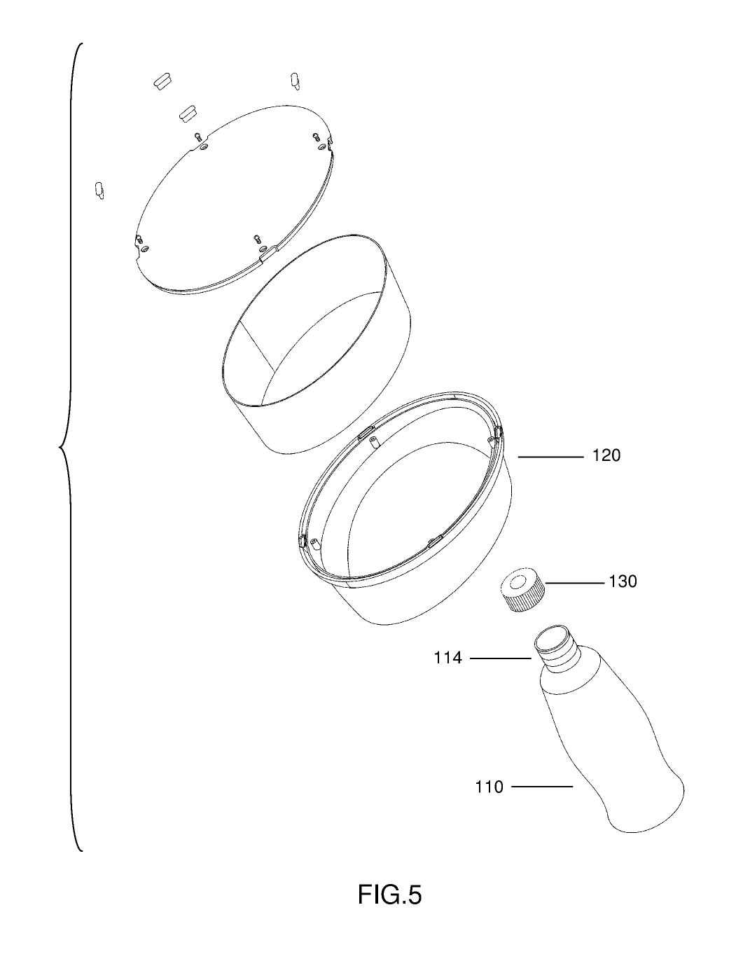

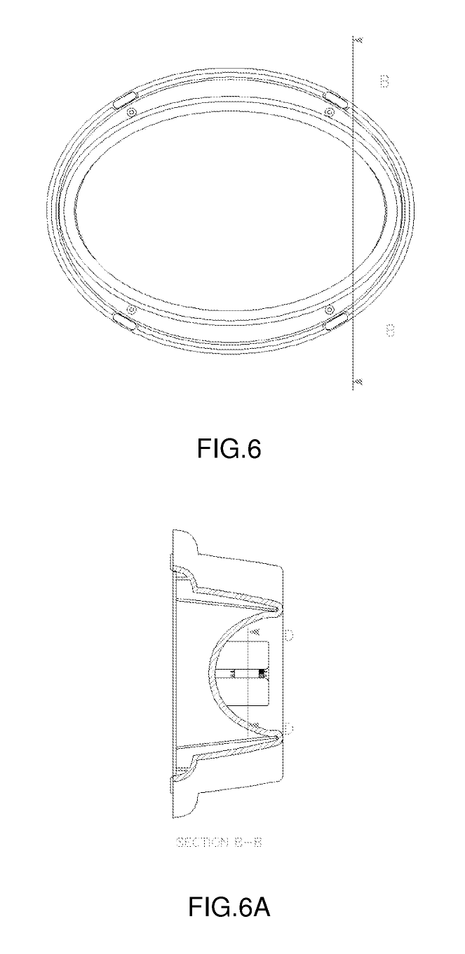

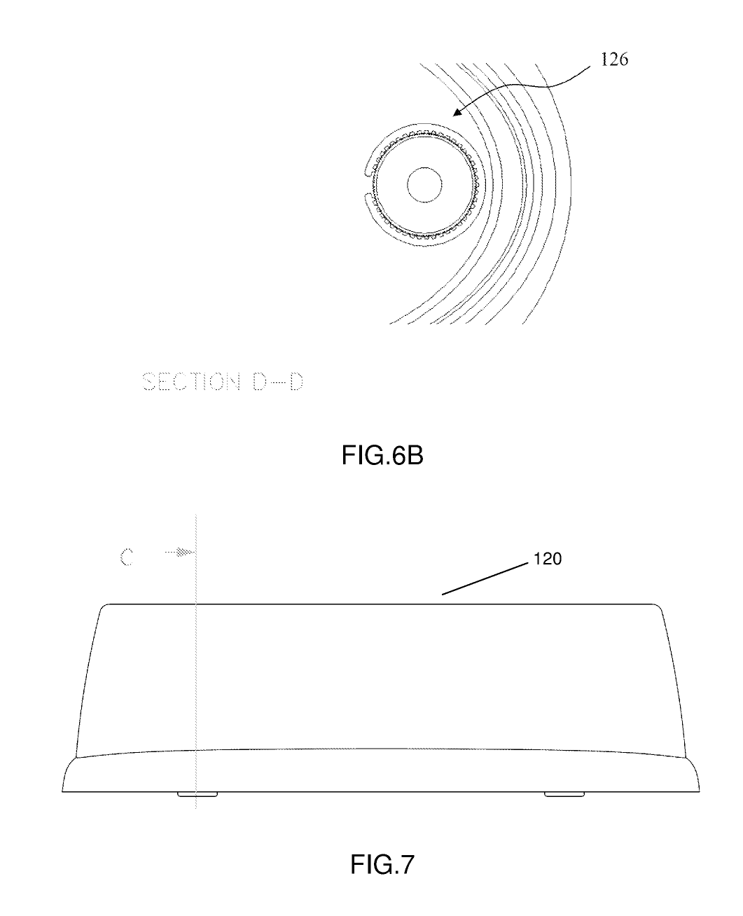

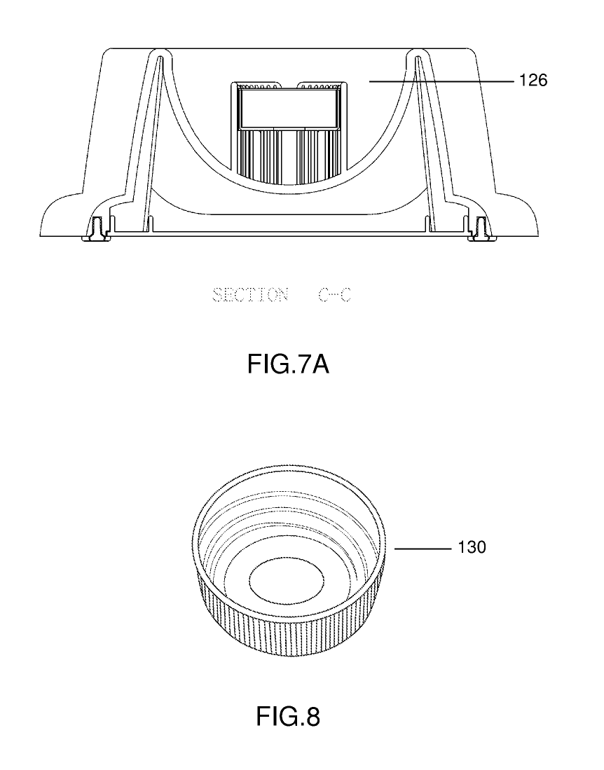

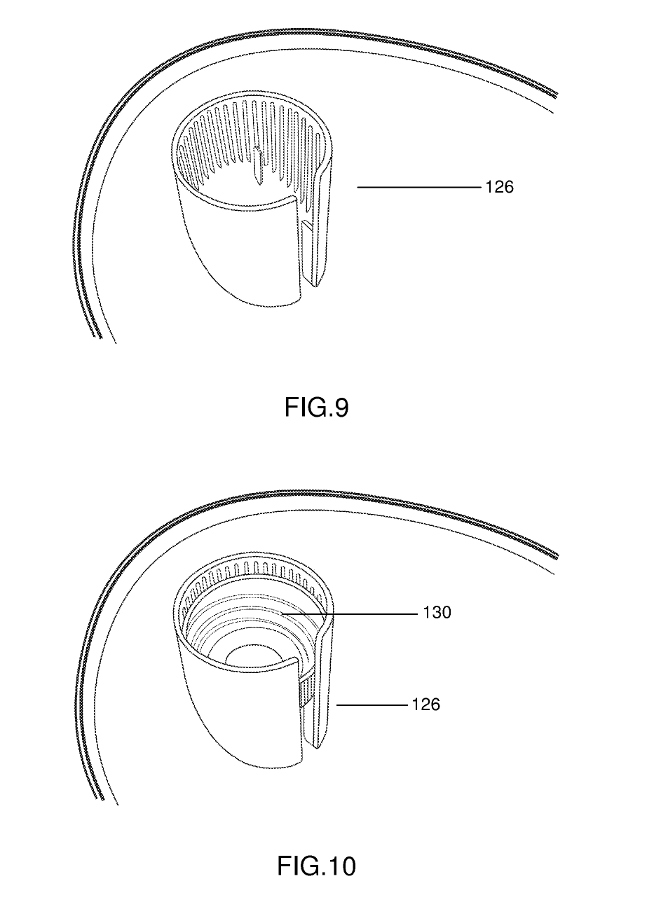

The pet water feeder 100 of FIGS. 1 to 5 comprises a plastic water bottle 110 as an exemplary embodiment of a first container, a moulded water bowl 120 as an exemplary embodiment of a base portion, and a through collar with internal threads as an exemplary embodiment of an adaptor.

The plastic water bottle is a stable plastic water bottle, such as a typical 2-liter soft drink bottle. The bottle comprises a closed bottom end, an open end and a peripheral wall interconnecting the closed and open ends. The open end comprises a neck portion with external threads 112, which are generally adapted for engagement with a compatibly threaded cap for closure.

The water bowl comprises a moulded plastic housing 122 which defines a drinking reservoir 124 and a bottle receptacle 126. The bottle receptacle is adapted to receive the open end of the water bottle and to support the filled water bottle in an upright manner with the closed end vertically above the open end. The lower end of the bottle receptacle defines a water inlet which is in communication with the drinking reservoir.

The bottle receptacle and the reservoir are arranged such that water entering the bottle receptacle from the open end of the filled water bottle due to gravitation will flow into the reservoir through the water inlet due to a difference in potential. The flowing will stop when the water in the reservoir is leveled with the lower end rim of the bottle.

In order to facilitate the use of staple water bottles with the water bowl, an adaptor 130 for engaging with both the neck portion 114 of the water bottle and the receptacle on the bowl is provided to mitigate the need of custom made bottles which are specifically moulded for the bowl. The adaptor provides an useful adaptation between the neck portion of the water bottle and the inlet portion of the bowl for secured engagement between the two parts and allow water to pass through.

The exemplary adaptor comprises a moulded collar with internal threads matching those on the neck portion of the water bottle. The external surface of the collar is moulded to be compatible to the internal surface of the receptacle to ensure tight fit when engaged. The adaptor may be similar to a conventional plastic screw cap of a plastic water bottle, except that an aperture is formed at the otherwise closed end of the screw cap to provide through passage for water to egress from the bottle neck to the reservoir. The length of the collar, which is the axial or longitudinal extension of the collar, is approximately the same as that of the neck portion of the bottle to provide necessary vertical support. The length of the collar could of course be altered to suit specific mechanical requirements.

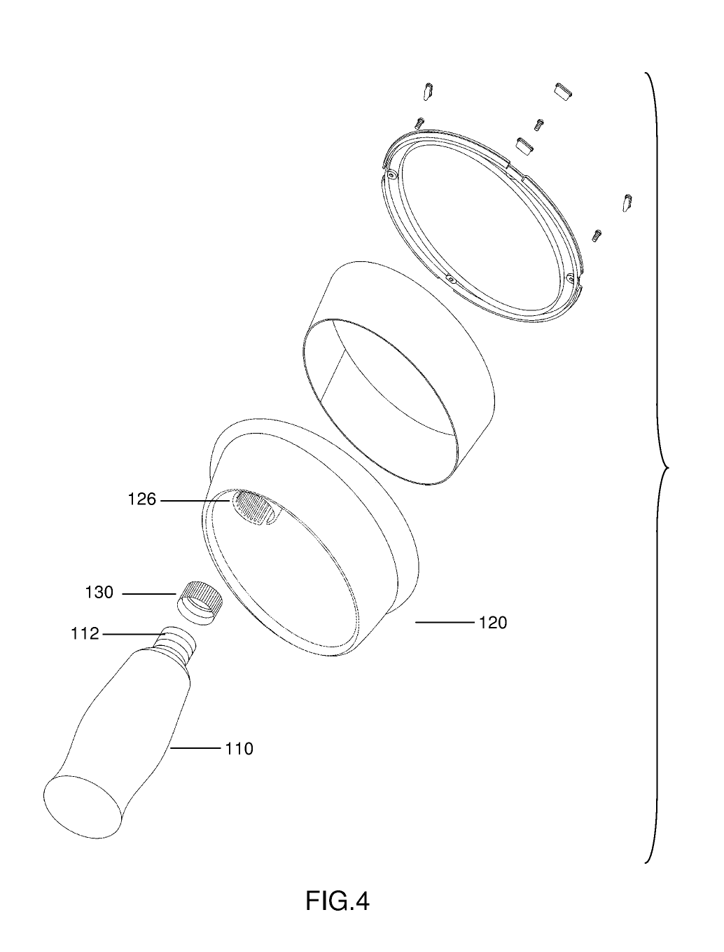

In the embodiment of FIG. 4, longitudinal splines are distributed on the internal surface of the receptacle. The splines provide enforcement to the receptacle or the inlet portion so that a larger bottle filled with a larger quantity of water can be comfortably supported. Correspondingly shaped splines are also formed on the collar to ensure tight and strong fit between the inlet portion and the receptacle and to reduce slipping between the outer surface of adaptor and the internal surface of the receptacle when screwing in the water bottle. Furthermore, the splines or ribs of the receptacle could also be shaped or configuration for determination of the depth of the water bottle to be inserted. This would provide an effective way to determine the water level.

To assemble the pet water feeder, the container is first filled with water, the adaptor is then screwed tightly onto the neck portion of the water bottle. The assembled bottle is then inserted into the receptacle on the water bowl. The close mechanical fitting between the bottle and the bowl, due to a close mechanical fitting between the neck portion, the inlet, and the adaptor ensures a tight and strong fit to support an inverted bottle filled with water. Water begins to flow into the bowl until the water level reaches the lower end of the bottle, and will automatically re-start water dispensing after the water level in the bowl drops below the lower end of the collar.

While the present invention has been explained with reference to the above embodiments, it will be understood by persons skilled in the art that the examples are non-limiting. For example, the splines on the inside surface of the inlet are only optional. Alternatively, longitudinally extending ribs and grooves can be distributed respectively on the collar and the inlet or vice versa for close fit without loss of generality.

What is claimed is:

1. A pet water feeder comprising a first container having a main body and a threaded neck portion, a base portion defining a reservoir and having an inlet portion, and an adaptor; wherein the adaptor comprises a first engaging portion for engaging with the threaded neck portion and a second engagement portion for engaging with the inlet portion.

2. A pet water feeder according to claim 1, wherein the second engagement portion is adapted for press-fitted engagement with the inlet portion.

3. A pet water feeder according to claim 2, wherein the adaptor comprises a moulded cylindrical peripheral wall having internal threads for engaging with the threaded neck portion, the exterior of the cylindrical peripheral wall being adapted for press-fitted engagement with the inlet portion of the reservoir.

4. A pet water feeder according to claim 3, wherein longitudinally running splines or ribs are formed on the exterior of the cylindrical peripheral wall.

5. A pet water feeder according to claim 1, wherein the first container is a drink container moulded of hard plastics, preferable transparent plastics.

6. A pet water feeder according to claim 5, wherein the drink container is a standard-sized plastic bottle for containing drinks for human consumption.

7. A pet water feeder according to claim 1, wherein the reservoir is a moulded of hard plastics, the reservoir defining an open access for drinking by a pet.

8. A pet water feeder according to claim 1, wherein the first container is arranged to discharge liquid from the main body into the reservoir by gravitation.

9. A pet water feeder according to claim 1, wherein the adaptor is adapted for detachable engagement with both the inlet portion of the reservoir and the necked portion of the first container.

10. A pet water feeder according to claim 1, wherein the adaptor is a threaded collar having open ends.

11. A pet water feeder according to claim 1, wherein the inlet portion on the base portion comprises longitudinally running splines for engagement with the outside of the adaptor.

12. A pet water feeder according to claim 1, wherein the first container is a bottle having an open end with the threaded neck portion, the bottle being arranged so that the open end of the bottle defines the drinking water level in the reservoir during normal use.
